(19) United States
(12) Patent Application Publication
(10) Pub. No.: US 2014/0203938 A1
(43) Pub. Date: Jul. 24, 2014

(54) SYSTEM AND METHOD FOR BURN PREVENTION

(71) Applicant: ROM ACQUISITION CORPORATION, Belton, MO (US)

(72) Inventors: John E. McLoughlin, Hauppauge, NY (US); Neocles G. Athanasiades, E. Setauket, NY (US); Robert J. Galazka, Selden, NY (US)

(73) Assignee: ROM ACQUISITION CORPORATION, Belton, MO (US)

(21) Appl. No.: 14/076,452

(22) Filed: Nov. 11, 2013

Related U.S. Application Data
(60) Provisional application No. 61/755,027, filed on Jan. 22, 2013.

(51) Int. Cl. G08B 21/02

(52) U.S. Cl. CPC G08B 21/02
USPC 340/584

(57) ABSTRACT

A system comprises a plurality of temperature sensors adapted to measure the temperature at various locations on a firefighter's turnout gear and helmet, and operable to generate temperature measurements, a microcontroller configured to receive the temperature measurements from the plurality of temperature sensors, and to analyze the temperature measurements and determine the temperature status of the firefighter's environment, a visual interface in communication with the microcontroller and configured to provide a visual indication of the firefighter's temperature status, an audible alert device in communication with the microcontroller and configured to provide an audible alert of the firefighter's temperature status, and a command center configured to receive the temperature measurements and the temperature status from the microcontroller, and to display this information.

### RELATED APPLICATION

The present application claims the benefit of Provisional Patent Application No. 61/755,027 filed on Jan. 22, 2013.

### FIELD

The present disclosure generally relates to firefighting equipment, and more particularly to a system and method for burn prevention in firefighting applications.

### BACKGROUND

Firefighting is a highly risky occupation that subjects firefighters to many hazards. Firefighters often enter burning structures to save lives or put out fires. The condition of a burning building may deteriorate quickly due to a variety reasons that cannot be anticipated. Because they are insulated from the heat by protective turnout gear as they perform tasks that require a high degree of concentration, firefighters may not realize that their surrounding temperature has reached dangerous levels. Although firefighters wear turnout gear constructed of fire resistant materials equipped with Self-Contained Breathing Apparatus (SCUBA) and a Personal Alert Safety System (PASS), more degrees of protection are desirable to provide additional safeguards against injury and harm.

### SUMMARY

A system comprises at least one temperature sensor adapted to measure the temperature at at least one location on a firefighter's turnout gear and helmet, and operable to generate temperature measurements, a microcontroller configured to receive the temperature measurements from the at least one temperature sensor, and to analyze the temperature measurements and determine the temperature status of the firefighter's environment, a visual interface in communication with the microcontroller and configured to provide a visual indication of the firefighter's temperature status, an audible alert device in communication with the microcontroller and configured to provide an audible alert of the firefighter's temperature status, and a command center configured to receive the temperature measurements and the temperature status from the microcontroller, and to display this information.

A method comprises receiving a plurality of temperature measurements taken from various locations on a firefighter's gear and helmet, analyzing the temperature measurements and determining the temperature status of the firefighter's environment, providing a visual indication of the firefighter's temperature status, providing an audible alert of the firefighter's temperature status, and wirelessly transmitting the temperature measurements and the temperature status to a command center to display this information.

A system comprises a plurality of temperature sensors adapted to measure the ambient temperature around a firefighter, and operable to generate temperature measurements, a microcontroller configured to receive the temperature measurements from the plurality of temperature sensors, and to analyze the temperature measurements and determine the temperature status of the firefighter's environment, a visual interface in communication with the microcontroller and configured to provide a visual indication of the firefighter's temperature status, an audible alert device in communication with the microcontroller and configured to provide an audible alert of the firefighter's temperature status, a tactile alert device in communication with the microcontroller and configured to provide an tactile alert of the firefighter's temperature status, and a command center configured to receive the temperature measurements and the temperature status from the microcontroller, and to display this information.

### DESCRIPTION OF THE DRAWINGS

FIG. 1 is a simplified block diagram of an exemplary embodiment of the burn prevention system according to the present disclosure; and

FIG. 2 is a simplified flowchart of an exemplary embodiment of the burn prevention method according to the present disclosure.

### DETAILED DESCRIPTION

U.S. Pat. No. 6,075,445 describes a High-Temperature Warning Unit, which is incorporated herein by reference.

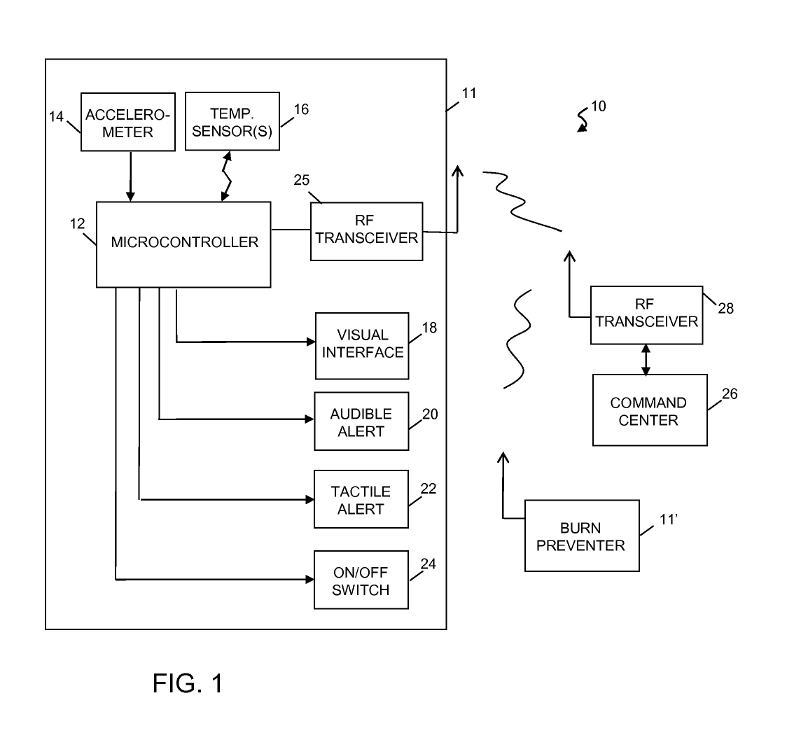

FIG. 1 is a simplified block diagram of an exemplary embodiment of the burn prevention system 10 according to the present disclosure. System 10 includes a plurality of burn preventer devices 11 and 11′ that is worn, carried, or otherwise attached to a plurality of firefighters' gear and helmet. Each burn preventer includes a microprocessor or microcontroller 12 that receives output signals from a motion detecting device 14 such as an accelerometer and one or more temperature sensors 16. The temperature sensors 16 may be securely located at various locations on the firefighter's helmet, chest, sleeves, back, etc. The signals generated at the motion detecting device 14 and temperature sensors 16 may be transmitted to the microcontroller either via wires and/or suitable wireless transmission protocols. The microcontroller 12 is further communicatively coupled to one or more user interface devices, including a visual interface device 18, an audible alert device 20, a tactile alert device 22, and an on/off switch 24. The visual interface device 18 may include one or more light-emitting diodes (LEDs) that are operable to emit light in one of many colors to signal an alert level or alert status. For example, when the system 10 is on standby in ready status, the LED may emit a steady green light. When the microcontroller 12 receives a temperature measurement in a range where a firefighter should not remain for a prolonged time, such as at 240° F. for longer than 5 minutes, for example, the microcontroller 12 may cause the LED to emit a flashing yellow light, and the tactile alert device 22 to vibrate. When microcontroller 12 receives a temperature measurement in the unsafe or hazardous range, for example, 400° F., the microcontroller 12 may cause the LED to emit a flashing red light, and the tactile alert device 22 to vibrate, for example. The visual interface device 18 may include a small display screen that is operable to present information such as system status, sensed temperature, system parameters and settings, for example. The visual interface device 18 is preferably mounted on the firefighter's helmet including on the visor, for example. Accordingly, a suitable combination of visual, audible, and tactile alert methods may be used to ensure that the firefighter becomes aware of the high or rising temperatures in his or her surroundings.

The microcontroller 12 is further in wireless communication via a radio frequency (RF) transceiver 25 with a command center 26. The command center 26 includes a central control computer system with a wired and/or wireless communications system with an RF transceiver 28 to receive and monitor various sensor data and measurements to control and regulate fire truck equipment operations, including engine, engine control module, power take-off (PTO), main centrifugal pump, pump governor, hydraulic subsystem, chemical foam subsystem, air compressor subsystem, and electrical subsystem, monitor resources such as water and chemical foam tanks, fire hydrant or other supply line pressure, and fire hose discharge valve pressure. The command center 26 also receives and monitors firefighter physiological data from the firefighters' air packs, helmets, turnout gear, and other equipment, including temperature measurements. The system is operable to automatically react to monitored sensor outputs and other data, regulate all functions of these equipment and devices, including input and discharge water control, electrical and lighting controls, air pressure control, hydraulic system control, and issues warnings and other alerts to firefighting personnel.

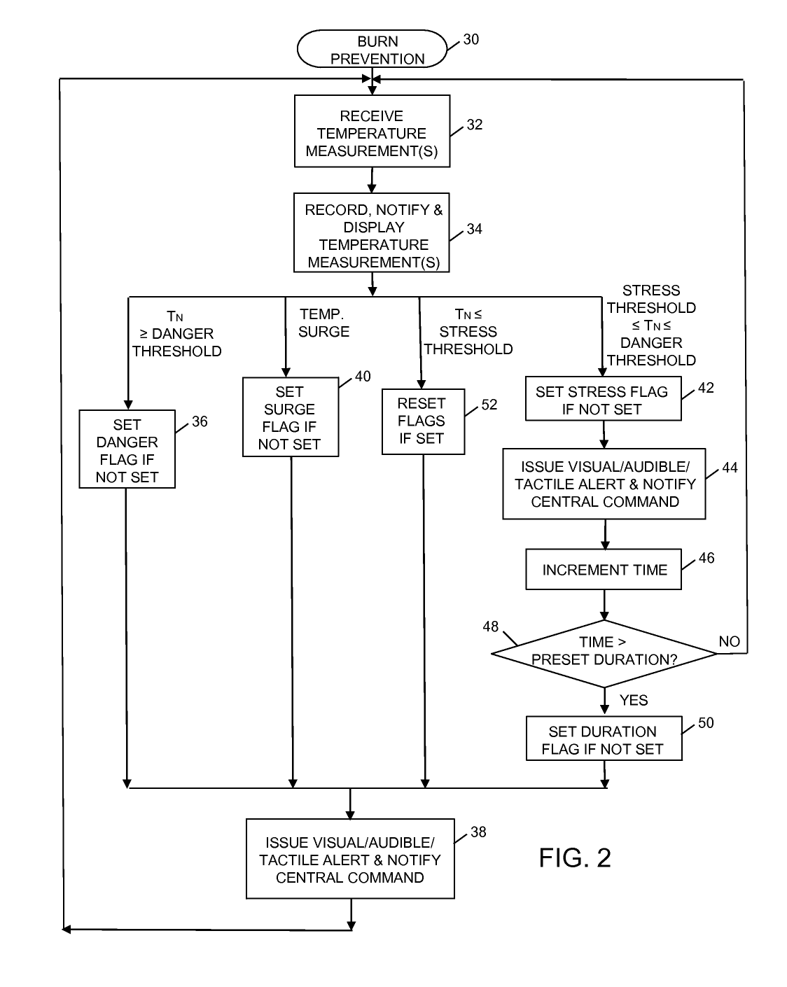

FIG. 2 is a simplified flowchart of an exemplary embodiment of the burn prevention method 30 according to the present disclosure. The burn preventer 11 may be turned on via the manual on/off switch 24 or automatically by sensing motion via the accelerometer 14. In block 32, the microcontroller 12 receives one or more temperature measurements T_{N} (where N=1, 2, . . . , n) from the temperature sensors 16. The temperature measurements preferably represent the ambient temperature at various points on the firefighter turnout gear and helmet. The temperature measurements may be logged in memory with timestamp, as shown in block 34. The temperature measurements may also be displayed on a small screen that can be viewed by the firefighter as well as transmitted to the command center 26.

The temperature measurements are then compared to a number of conditions or thresholds. If any of the temperature measurements is above a certain predetermined or programmed danger threshold, e.g., 400° F., a danger condition flag is set in block 36. The danger threshold represents a temperature above which life of the firefighter would be in grave danger. Thereafter, an appropriate alert (visual, audible, and/or tactile) is issued in block 38. An appropriate notification of this dangerous condition is also sent to the command center 26 as indicated by the danger flag. The alert and notification are repeated as long as any of the temperature measurements remain in the danger zone, as indicated by the danger flag being set. The firefighter should immediately retreat from the area when the danger condition alerts are issued.

The temperature measurements are also monitored to detect a predetermined or programmed temperature surge condition, such as when one of the temperature measurements increases at the rate of 5° F. per second or more. Such temperature surge is indicative of a dangerous condition prone to an imminent flashover, which involves a near simultaneous ignition of combustible materials in an enclosed area. At the detection of such condition, the temperature surge flag is set in block 40, the appropriate alert is issued to notify the firefighter, and a notification of this dangerous condition (as indicated by the temperature surge flag) is also sent to the command center 26. The firefighter should immediately retreat from the area when the temperature surge alerts are issued.

The temperature measurements are also monitored to determine whether the firefighter is being exposed to a temperature range that would cause stress due to prolonged exposure. For example, if any of the temperature measurements is above a predetermined or programmed stress threshold, e.g., 240° F., but under the danger threshold, e.g., 400° F., a stress flag is set in block 42. A visual/audible/tactile alert is issued to the firefighter in response to the stress level temperature measurements and the command center is also notified in block 44. The firefighter is thus made aware of the risky situation by at least one of the alert methods. The status and temperature data may be displayed and made available to the firefighter. The temperature measurements and the alert status may be part of the notification message to the command center. In block 46, a time variable is incremented. If in block 48 a determination is made that any of the temperature measurements has been at the stress level for longer than a preset duration, e.g., five minutes, then another alert (visual, audible, and/or tactile) is issued to the firefighter and a duration flag is set in block 50. If the time has not reached the predetermined or programmed duration, then the process returns to block 32 for more temperature measurements. In block 38, the stress condition status is transmitted to the command center 26 according to the stress flag and the duration flags.

If in any iteration none of the temperature measurements meets any of the stress, danger, or surge conditions, then the ambient temperature is in the safe range, and the flags are reset if any have been previously set, in block 52. Similarly, the stress time counter is reset (if its value is non-zero) in block 54 if the temperature is normal.

Therefore, in operation, burn prevention system and method is operable to detect various dangerous conditions, and the firefighter is alerted to any existing dangerous condition by appropriate visual, audio, and/or tactile methods. Further, the command center receives notification or reports of the firefighters' current status on a real-time or near real-time basis. With this information, the incident commander is able to have a more accurate view of the firefighters deployed at the scene, as well as information on the conditions at various points in the burning structure. If a firefighter's temperature sensors are detecting ambient temperatures at dangerous levels indicative of imminent flashover, the incident commander can immediately instruct that firefighter as well as firefighters in the vicinity to evacuate the area, even when those other firefighters' devices have not yet detected the dangerous conditions.

It should be noted that the burn preventer device 11 is enclosed in a protective housing that is preferably flame resistant and can withstand high temperatures. The housing preferably incorporates insulation materials to further protect the circuitry inside. The housing also comprises means for secure attachment to the firefighter's helmet or turnout gear. The display may be incorporated into the firefighter's face shield in the form of a heads-up display, for example.

Further notice should be given regarding the actual implementation of the system in that certain changes and modifications to the described system, though not described explicitly or in detail, are contemplated herein. For example, the microcontroller may be implemented using one or more CPU, processor, or micro-controller circuits. Further, it is understood that a CPU is typically in operation with its attendant circuitry and software, such as memory, interfaces, drivers, etc. as known in the art. Additionally, although not shown explicitly, the system includes memory that may be implemented using one or more data storage devices of a variety of types now known or later developed. Similarly, the system may employ wireless communication that may be achieved using any technology and protocol suitable for the firefighting application. Although wireless communication is the general way information may be conveyed, the communication between the microcontroller and any controlled component and sensor may be achieved by wired and/or wireless means.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

What is claimed is:

1. A system comprising:
At least one temperature sensor adapted to measure the temperature at at least one location on a firefighter's turnout gear and helmet, and operable to generate temperature measurements;
a microcontroller configured to receive the temperature measurements from the at least one temperature sensor, and to analyze the temperature measurements and determine the temperature status of the firefighter's environment;
a visual interface in communication with the microcontroller and configured to provide a visual indication of the firefighter's temperature status;
an audible alert device in communication with the microcontroller and configured to provide an audible alert of the firefighter's temperature status; and
a command center configured to receive the temperature measurements and the temperature status from the microcontroller, and to display this information

2. The system of claim 1 further comprising a tactile alert device in communication with the microcontroller and configured to provide an tactile alert of the firefighter's temperature status.

3. The system of claim 1 wherein the microcontroller is further configured to compare the received temperature measurements to a plurality of temperature thresholds, to issue a danger alert in response to any of the temperature measurements exceeding a danger temperature threshold, and to transmit the issued alert to the command center.

4. The system of claim 1 wherein the microcontroller is further configured to compare the received temperature measurements to a plurality of temperature thresholds, to issue a stress alert in response to any of the temperature measurements falling within a stress temperature threshold for a duration of time, and to transmit the issued alert to the command center.

5. The system of claim 1 wherein the microcontroller is further configured to compare the received temperature measurements to a plurality of temperature thresholds, to issue a temperature surge alert in response to any of the temperature measurements increasing at a high rate, and to transmit the issued alert to the command center.

6. The system of claim 1 wherein the microcontroller is further configured to compare the received temperature measurements to a plurality of temperature thresholds, and to issue a normal temperature status in response to all of the temperature measurements being in a normal range, and to transmit the normal temperature status to the command center.

7. The system of claim 1, wherein the visual interface comprises at least one light-emitting diode (LED) operable to emit light in at least two colors in steady and flashing modes indicative of the various temperature statuses.

8. The system of claim 1, wherein the visual interface comprises a display screen operable to display the temperature status of the firefighter.

9. The system of claim 1, wherein the microcontroller and the command center communicate via wireless communication.

10. The system of claim 1, wherein the microcontroller and the plurality of temperature sensors communicate via wireless communication.

11. A method comprising:
receiving a plurality of temperature measurements taken from various locations on a firefighter's gear and helmet;
analyzing the temperature measurements and determining the temperature status of the firefighter's environment;
providing a visual indication of the firefighter's temperature status;
providing an audible alert of the firefighter's temperature status; and
wirelessly transmitting the temperature measurements and the temperature status to a command center to display this information.

12. The method of claim 11, further comprises providing an tactile alert of the firefighter's temperature status.

13. The method of claim 11, wherein analyzing the temperature measurements comprises comparing the received temperature measurements to a plurality of temperature thresholds.

14. The method of claim 13, further comprising issuing a danger alert in response to any of the temperature measurements exceeding a danger temperature threshold, and transmitting the alert status to the command center.

15. The method of claim 13, further comprising issuing a stress alert in response to any of the temperature measurements falling within a stress temperature threshold for a duration of time, and transmitting the alert status to the command center.

16. The method of claim 13, further comprising issuing a temperature surge alert in response to any of the temperature measurements increasing at a high rate, and transmitting the alert status to the command center.

17. The method of claim 13, further comprising issuing a normal temperature status in response to all of the temperature measurements being in a normal range, and transmitting the normal temperature status to the command center.

18. The method of claim 11, wherein providing a visual indication comprises emitting light in at least two colors in steady and flashing modes indicative of the various temperature statuses.

19. The method of claim 11, wherein providing a visual indication comprises displaying the temperature status of the firefighter.

20. A system comprising:
a plurality of temperature sensors adapted to measure the ambient temperature around a firefighter, and operable to generate temperature measurements;
a microcontroller configured to receive the temperature measurements from the plurality of temperature sensors, and to analyze the temperature measurements and determine the temperature status of the firefighter's environment;
a visual interface in communication with the microcontroller and configured to provide a visual indication of the firefighter's temperature status;
an audible alert device in communication with the microcontroller and configured to provide an audible alert of the firefighter's temperature status;
a tactile alert device in communication with the microcontroller and configured to provide an tactile alert of the firefighter's temperature status; and
a command center configured to receive the temperature measurements and the temperature status from the microcontroller, and to display this information

21. The system of claim 20 wherein the microcontroller is further configured to compare the received temperature measurements to a plurality of temperature thresholds, to issue a danger alert in response to any of the temperature measurements exceeding a danger temperature threshold, and to transmit the alert status to the command center.

22. The system of claim 20 wherein the microcontroller is further configured to compare the received temperature measurements to a plurality of temperature thresholds, to issue a stress alert in response to any of the temperature measurements falling within a stress temperature threshold for a duration of time, and to transmit the alert status to the command center.

23. The system of claim 20 wherein the microcontroller is further configured to compare the received temperature measurements to a plurality of temperature thresholds, to issue a temperature surge alert in response to any of the temperature measurements increasing at a high rate, and to transmit the alert status to the command center.

24. The system of claim 20 wherein the microcontroller is further configured to compare the received temperature measurements to a plurality of temperature thresholds, and to issue a normal temperature status in response to all of the temperature measurements being in a normal range, and to transmit the normal temperature status to the command center.
